(19) United States
(12) Patent Application Publication
(10) Pub. No.: US 2026/0359760 A1
(43) Pub. Date: Nov. 12, 2026

(54) SYSTEM AND METHOD FOR AUTOMATICALLY GENERATING AND DISPLAYING RISK ASSESSMENT RESULTS

(71) Applicant: Level ADR Inc., New York, NY (US)

(72) Inventor: David Alan LeVine, Sarasota, FL (US)

(73) Assignee: Level ADR Inc., New York, NY (US)

(21) Appl. No.: 19/202,440

(22) Filed: May 8, 2025

(51) Int. Cl. G06Q 10/0635; G06Q 50/18

(52) U.S. Cl. CPC G06Q 10/0635; G06Q 50/18

(57) ABSTRACT

A method and system for automatically generating and displaying risk assessment results to more efficiently process risk is carried out by a non-transitory computer readable media comprising computer program code that when executed by a programmable processor causes execution of the method. The method is performed by a computer system. The non-transitory computer readable media comprises computer program code for receiving risk data from one or more users via a user interface over a communication network. The non-transitory computer readable media comprises computer program code for processing, via a computational engine, the risk data using one or more risk assessment methodologies to calculate a risk value. The non-transitory computer readable media also comprises computer program code for generating a visual display comprising multi-methodology integration results from the one or more risk assessment methodologies.

### RELATED APPLICATIONS

The present application is related to co-pending U.S. patent application Publication Ser. No. 19/198,381, entitled “SYSTEM AND METHOD FOR AUTOMATICALLY GENERATING AND DISPLAYING A MATRIX DATA STRUCTURE,” filed on May 5, 2025 the disclosure of which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to the field of legal risk analysis, and more specifically, but not exclusively, to automatically generating and displaying risk assessment results to more efficiently calculate risk.

### Description of the Related Art

Accurate and efficient legal risk analysis is crucial for helping clients and attorneys make informed decisions about litigation and settlement strategies during legal dispute resolution. Accurately and efficiently processing legal risk requires extensive data input, complex calculations, and specialized knowledge of multiple analytical methodologies for risk calculation, making it difficult to accurately account for all factors that could affect legal risk. The complexities involved in legal risk calculation leads to reduced effectiveness, especially when working with clients who do not have extensive experience with legal risk analysis.

Traditional systems have relied on a single methodology to calculate risk analysis, require extensive data input and expertise to function, provide only basic probability functions and lack the integration of multiple analytical frameworks, and require significant training to use effectively. Accordingly, traditional systems are deficient to process complex risk analyses that are excessively complex in their data input requirements. Further, traditional systems are incapable of integrating multiple integration methodologies. Traditional systems are also deficient because they provide output that is difficult for non-experts to interpret, and they cannot be easily adjusted to account for case-specific factors. Traditional systems also fail to provide integrated visual representations of different risk factors.

Further, traditional systems fail to address the technical challenges of accounting for concurrency, real-time interaction between users, and secure data handling for multiple users or devices accessing the system simultaneously. As a result, traditional systems exhibit high latency, incomplete synchronization of toggles, and fragmented user experiences.

For example, in U.S. Pat. No. 11,948,113, the system, method, and computer program for generating risk assessment software based on historical data uses parsed text streams to extract/construct risk identifiers. This system and method are deficient because it fails to calculate risk based on multiple risk methodologies, thereby lacking efficiency.

In U.S. Patent Application Publication No. 2003/0126049, the system and method involve a series of targeted questions presented to a potential insurance customer or interested party which allows the system to project a level of risk and potential loss based on the responses. This system is deficient because it fails to allow for dynamic probability adjustments based on factor/specific designations and fails to provide an interactive visualization integrating multiple analytical methods of risk analysis.

In U.S. Pat. No. 12,039,612, the system identifies a risk datum as a function of user input and a calculation metric and generates a projection report as a function of a risk assessment machine learning model. This system is deficient because it fails to provide an interactive legal decision-support system that enhances user comprehension through structured probability tiers and real-time visualization of legal risks.

In U.S. Patent Application Publication No. 2002/0143562, the system assesses risks based upon criteria such as data descriptions of parties to a legal action, individuals advising and/or controlling the parties to a legal action, historical data, interpretation of world events or other associated input. The system generates a risk quotient or other qualitative rating based upon a weighted algorithm applied to the criteria, wherein the risk quotient is indicative of risks associated with an account. This system is deficient because it fails to provide a visualized, multi-methodology legal risk analysis system.

The current solutions are thus incomplete when it comes to generating and visualizing a comprehensive legal risk assessment. Existing patents and systems fail to minimize data input requirements while maintaining analytical rigor. Existing patents and systems also fail to combine multiple risk assessment methodologies into a unified framework, present results in an understandable visual format for all users, allow for easy adjustments based on case-specific factors, and provide a clear progression from best to worst-case scenarios.

Therefore, there is a need in the art for improved systems and methods for generating and displaying risk assessment results to more efficiently process risk.

### SUMMARY OF THE INVENTION

The present invention provides a method and system for automatically generating and displaying risk assessment results to more efficiently process risk. According to an embodiment, the method for automatically generating and displaying risk assessment results to more efficiently process risk is carried out by a non-transitory computer readable media comprising computer program code that when executed by a programmable processor causes execution of the method. The method is performed by a computer system.

The non-transitory computer readable media comprises computer program code for receiving risk data from one or more users via a user interface over a communication network. The non-transitory computer readable media comprises computer program code for processing, via a computational engine, the risk data using one or more risk assessment methodologies to calculate a risk value. The non-transitory computer readable media also comprises computer program code for generating a visual display comprising multi-methodology integration results from the one or more risk assessment methodologies.

In some embodiments, the non-transitory computer readable media can further comprise computer program code for receiving changes to the risk data made by the one or more users via an interactive control module, processing, via the computational engine, the received changes to the risk data using the one or more risk assessment methodologies to recalculate the risk value, and generating an updated visual display based on the recalculated risk value. The computational engine can be configured to integrate the one or more risk assessment methodologies. The one or more risk assessment methodologies can comprise at least one of an expected monetary value analysis, a decision tree analysis, a best alternative to a negotiated agreement analysis, and a worst alternative to a negotiated agreement analysis. The multi-methodology integration results can comprise at least one of a progression from a best case-scenario to a worst case-scenario, proportional probability distributions, and monetary values.

In certain embodiments, the non-transitory computer readable media can further comprise computer program code for continuously processing, via the computational engine, the proportional probability distributions from the one or more users. The non-transitory computer readable media can also comprise computer program code for continuously calculating, via the computational engine, monetary values and continuously processing, via the computational engine, the progression from the best case-scenario to the worst case-scenario.

In certain other embodiments, the non-transitory computer readable media can further comprise computer program code for generating one or more targeted questions for the one or more users to answer. The one or more targeted questions can capture essential risk factors and case specific parameters. The non-transitory computer readable media can further comprise computer program code for receiving answers from the one or more users relating to the one or more targeted questions. The answers can comprise data relating to at least one of a maximum gain assessment, a maximum loss assessment, a most likely win amount, a most likely loss amount, a probability assessment, a legal cost estimation, a time estimation, and case specific factors.

The probability assessment can comprise a multi-level probability scale for assessing likelihood of a given risk factor. The case-specific factors can comprise at least one of documentary evidence, witness testimony and availability, legal precedents, expert opinions, and opposition's case strength. Each of the case-specific factors can be designated as strong, weak, or not applicable by the one or more users.

In some embodiments, the non-transitory computer readable media can further comprise computer program code for storing risk analysis history data. The risk analysis history data can comprise updates to the risk data made by the one or more users and calculation logs over time.

The present invention provides a method for legal risk analysis. According to an embodiment, a computer-implemented method for legal risk analysis comprises receiving risk data from one or more users via a user interface over a communication network and calculating a risk value based on the risk data using one or more risk assessment methodologies. The method further comprises continuously adjusting the risk data based on interactions from the one or more users and generating a visual display comprising multi-methodology integration results from the one or more risk assessment methodologies.

The one or more risk assessment methodologies can comprise at least one of an expected monetary value analysis, a decision tree analysis, a best alternative to a negotiated agreement and a worst alternative to a negotiated agreement analysis. The multi-methodology integration results can comprise at least one of a progression from a best case-scenario to a worst case-scenario, proportional probability distributions, and monetary values.

In some embodiments, the method can further comprise continuously processing, via the computational engine, the proportional probability distributions from the one or more users, continuously calculating, via the computational engine, monetary values, and continuously processing, via the computational engine, the progression from the best case-scenario to the worst case-scenario. The method can further comprise generating one or more targeted questions for the one or more users relating to the risk data and receiving answers to the one or more targeted questions from the one or more users. The answers can comprise data relating to at least one of a maximum gain assessment, a maximum loss assessment, a most likely win amount, a most likely loss amount, a probability assessment, a legal cost estimation, a time estimation, a present value calculation, and case specific factors.

In certain embodiments, the probability assessment can comprise a multi-level probability scale for assessing likelihood of a given risk factor. The case-specific factors can comprise at least one of documentary evidence, witness testimony and availability, legal precedents, expert opinions, and opposition's case strength. Each of the case-specific factors can be updated based on a percentage modification for each of the case specific factors, for example, a 10% modification.

In some embodiments, the method can further comprise storing risk analysis history data. The risk analysis history data can comprise updates to the risk data made by the one or more users and calculation logs over time.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a non-transitory computer readable media system for generating risk analysis results according to an embodiment of the present invention;

FIG. 2 illustrates a flowchart of a system architecture and data flow for generating risk analysis results according to an embodiment of the present invention;

FIG. 3 illustrates a flowchart of a calculation framework and methodology integration process according to an embodiment of the present invention;

FIG. 4 illustrates a flowchart of a calculation methodology framework according to an embodiment of the present invention;

FIG. 5 illustrates a flowchart of a temporal value adjustment process through multi-stage calculation according to an embodiment of the present invention;

FIG. 6 illustrates a security and validation framework according to an embodiment of the present invention;

FIG. 7 illustrates a factor impact integration workflow according to an embodiment of the present invention;

FIG. 8 illustrates a data persistence and audit architecture according to an embodiment of the present invention;

FIG. 9 illustrates an API framework according to an embodiment of the present invention;

FIG. 10A illustrates a user input interface of the system for generating risk analysis results according to an embodiment of the present invention;

FIG. 10B illustrates a continuation of the user input interface of FIG. 10A according to an embodiment of the present invention;

FIG. 11 illustrates a visual display interface of the system for generating risk analysis results according to an embodiment of the present invention; and

FIG. 12 illustrates a flowchart of a method for risk analysis according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present invention provides a system and method for legal risk analysis that combines multiple risk assessment methodologies into a unified and technologically improved visual framework. The invention significantly reduces complexity, while maintaining analytical rigor. The systems and methods described herein provide a simplified input system comprising targeted questions that capture essential risk factors and case parameters. The systems and methods can include a probability assessment scale that converts complex probability estimations into easily understandable ranges (e.g., converting the five-level probability selection into numerical values). The systems and methods further provide a standardized factor impact system that allows for case-specific adjustments through strong/weak/neutral selections. The systems and methods further provide an integrated visual display that presents multiple risk analysis methodologies in a single, coherent progression. The visual display includes interactive elements that allow users to toggle between different analytical views while maintaining visual consistency.

The systems and methods described herein provide a concurrency-safe, event-driven architecture that ensures multiple users, such as counsel, clients, and external experts, can update or view the analysis in real time without data collisions or latency issues. The system's enhanced data flow framework ensures that only changed parameters (e.g., factor designations or toggles) trigger recalculations, thereby improving efficiency. In some embodiments, concurrency-safe can refer to the system's ability to handle multiple simultaneous users or operations without data corruption or calculation errors, ensuring that all users see consistent, accurate results in real-time. In some embodiments, event-driven updates/data flows can refer to the system's architecture where calculations and display updates are triggered by specific user actions or data changes, rather than occurring at fixed intervals.

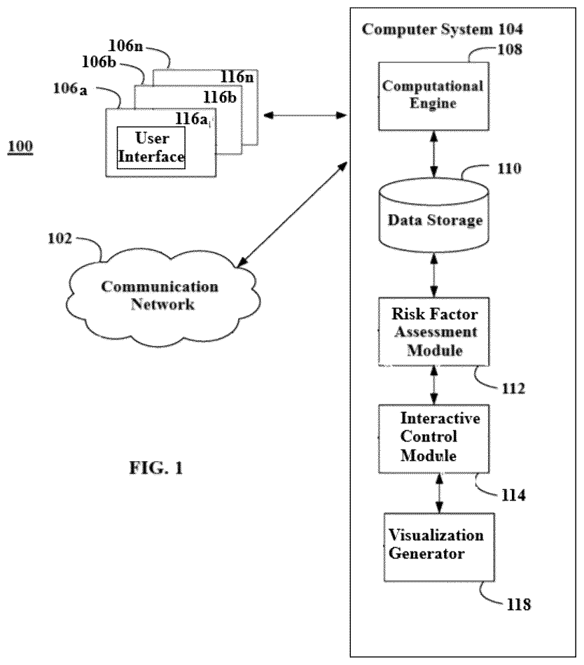

According to an embodiment, the invention provides a method and system for automatically generating and displaying risk assessment results to more efficiently process risk. With reference to FIG. 1, a system 100 for automatically generating and displaying risk assessment results is shown. The system 100 includes a computer system 104 and one or more user devices 106a-106n. Each of the one or more user devices 106a-106n is accessed by one or more users via one or more user interfaces 116a-116n. The one or more user devices 106a-106n communicate with the computer system 104 via a communication network 102. The computer system 104 can include a computational engine 108, data storage 110, a risk factor impact assessment module 112, an interactive control module 114, and a visualization generator 118.

According to an embodiment, the method for automatically generating and displaying risk assessment results to more efficiently process risk is carried out by a non-transitory computer readable media comprising computer program code that when executed by a programmable processor causes execution of the method. The method is performed by a computer system (e.g., computer system 104 as shown in FIG. 1).

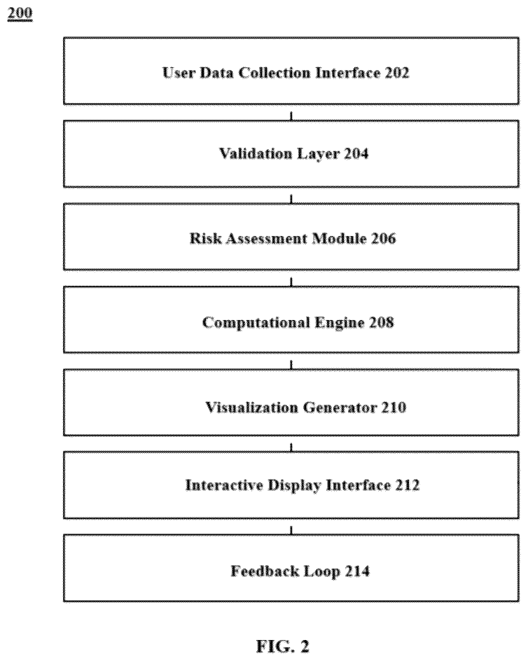

With reference to FIG. 2, a system architecture 200 of the system 100 is shown. The non-transitory computer readable media comprises computer program code for receiving risk data from one or more users via a user interface 202 over the communication network 102. Risk data is collected from one or more users through the user data collection interface 202 on the one or more user devices 106. The risk data inputted by each of the one or more users is validated via validation layer 204. Risk factor impact assessment occurs at risk assessment module 206 (e.g., as shown in FIG. 1, risk assessment module 112).

Risk data can be received through the user interface 202 via an input collection module. The validation layer 204 can ensure that a best alternative to a negotiation agreement (e.g., BATNA) is greater than a worst alternative to a negotiation agreement (e.g., WATNA). The validation layer 204 can further validate probability selections, confirm factor impact designations, verify temporal consistency, and validate cost inputs if concurrency is active. The validation layer 204 can also track user identity to ensure conflicting edits do not corrupt the database.

The systems and methods as described herein can incorporate machine learning capabilities to enhance risk assessment accuracy and provide predictive insights via the risk assessment module 206. The machine learning integration framework can include risk assessment refinement. The risk assessment refinement can include a supervised learning pipeline which includes training data from historical case outcomes and feature extraction from factor impacts. The risk assessment refinement can also provide probability calibration using past predictions and continuous model retraining. The risk assessment refinement can further include a neural network architecture which includes an input layer (e.g., having eight nodes to match eight core targeted questions), hidden layers (e.g., for factor impact processing), an output layer (e.g., for probability refinement), and an activation function (e.g., modified sigmoid for probability bounds).

The machine learning integration framework can also include a pattern recognition engine. The pattern recognition engine can provide a case similarity analysis which includes vector embedding of case parameters, cosine similarity calculations, nearest neighbor clustering, and outcome correlation detection. The pattern recognition engine can further provide temporal patten detection, including time series analysis of outcomes, seasonal adjustment factors, jurisdiction-specific trending statistics, and judge/court correlation analysis.

The machine learning integration framework can also include a predictive modelling system. The predictive modelling system can include an ensemble method implementation and a feature engineering pipeline. The ensemble method implementation can include random forest for factor importance, gradient boosting for probability refinement, neural networks for pattern detection, and model voting mechanisms. Ther feature engineering pipeline can include automated factor interaction detection, temporal feature extraction, jurisdictional feature encoding, and document similarity metrics.

The machine learning integration framework can further include a model integration framework. The model integration framework can include a real-time inference pipeline including async prediction generation, confidence score calculation, user feedback integration, and model performance monitoring. The model integration framework can also include fallback mechanisms, for example, default to traditional calculation, graceful degradation options, manual override capabilities, and confidence threshold enforcement.

With continued reference to FIG. 2, in some embodiments, risk factor impacts, process by the risk assessment module 206, can refer to case-specific elements that can influence outcome probability, including documentary evidence, witness testimony, legal precedents, expert opinions, and opposition case strength. Each risk impact factor can be designated as “strong” (positive impact), “weak” (negative impact), or “not applicable” (neutral impact). In some embodiments, factor impact designations can refer to the system's standardized method of quantifying the influence of case-specific factors, where “strong” factors add 10% (for example) to the base probability and “weak” factors subtract 10% (for example), subject to normalization.

Computational engine 208 (e.g., as shown in FIG. 1 as 108) can receive processed data from the user data collection interface 202 and risk assessment module 206 through secure data channels. The non-transitory computer readable media comprises computer program code for processing, via a computational engine 208, the risk data using one or more risk assessment methodologies to calculate a risk value. The computational engine 208 integrates the multiple risk methodologies with the data from the user interface 202 and the risk assessment module 206, processes probability adjustments (e.g., based on changes made by the one or more users), calculates monetary values, and performs temporal value adjustments (e.g. based on the probability adjustments).

The non-transitory computer readable media also comprises computer program code for generating a visual display via visualization generator 210 comprising multi-methodology integration results from the one or more risk assessment methodologies. In some embodiments, multi-methodology integration can refer to the system's combination of different risk analysis approaches (e.g., expected monetary value (e.g., EMV), decision tree analysis, best alternative to a negotiated agreement (e.g., BATNA) and worst alternative to a negotiated agreement (e.g., WATNA) analyses) into a single unified framework with consistent calculations and display.

In some embodiments, BATNA can refer to the most advantageous outcome that can be obtained without a counterparty's agreement. BATNA can represent the maximum potential gain in a complete-win scenario. In some embodiments WATNA can refer to the least favorable outcome that could occur without the counterparty's agreement. WATNA can represent the maximum potential loss in a complete-loss scenario. In some embodiments, EMV can refer to the probability-weighted average of all possible outcomes. EMV can be calculated by combining win probabilities with potential gains and loss probabilities with potential losses.

Visualization generator 210 combines the output from the computational engine 208 with display parameters to generate the visual display. The visual display is accessed by the one or more users via an interactive display interface 212. The interactive display interface 212 includes interactive controls which allow the one or more users to modify the display through the interactive display interface 212. As shown in FIG. 1, the interactive control module 114 includes the visualization generator 210, interactive display interface 212, and interactive user controls.

The visual display provides a framework which dynamically adapts to user interactions and device characteristics. The visual display framework can provide one or more users the ability to adjust risk data through a proportional calculation engine. Base proportional values can be derived from probability ratios. Dynamic recalculation of a risk value can be triggered by a present value toggle (e.g., applies temporal discount factors), an adjustment toggle (e.g., incorporates factor impact modifications), and a legal costs toggle (e.g., integrates fee structure impacts). The visual display framework can also provide normalization processing ensuring a consistent visual representation and a minimum section height enforcement (e.g., 10px) for visibility.

The visual display framework can also include interactive element processing including toggle state management, a real-time calculation pipeline, and a visual feedback system. The toggle state management can include independent state tracking per toggle, compound effect calculation for multiple active toggles, and transition management for smooth visual updates. The real-time calculation pipeline can include pre-calculation of alternative states, cached intermediate results, and a progressive update mechanism. The visual feedback system can include loading indicators for long calculations, animation for state transitions, and error state visualization.

The visual display framework can provide a responsive design architecture including a viewport-based scaling system, touch interaction handling, and device specific optimizations. The viewport-based scaling system can include dynamic resizing of visual elements, maintained proportional relationships, breakpoint-based layout adjustments, and minimum touch target sizes (e.g., 44px). The viewpoint based scaling system can further include responsive scaling across device types, gesture-based control manipulation, haptic feedback integration, print-optimized layout generation, accessibility compliance features, dynamic layout reconfiguration, and viewport-based size adaptation. Touch interaction handling can include multi-touch gesture support, drag-based adjustment capabilities, touch-friendly control placement, and haptic feedback integration. The device-specific optimizations allow for the system to be accessed on various types of user devices, for example, smart phones, laptops, desktops, tablets, and any other device capable of accessing the Internet. The device-specific optimizations can include mobile-first layout principles, tablet-optimized control placement, desktop enhancement, and print layout optimization.

The visual display framework can further include a visual calculation display. The visual calculation display can include probability section sizing. For example, base height (e.g., container_height*probability_ratio), minimum height enforcement, padding and margin calculations, and transition timing functions. The visual calculation display can include a value representation which provides currency formatting by locale, scientific notation for large values, percentage precision rules, and unit conversion handling.

In some embodiments, the visual display implementation can vertically arrange risk analysis components from most favorable to least favorable outcomes. This arrangement can comprise a vertical progression layout, a probability visualization, and interactive display elements. The vertical progression layout can include BATNA positioned at the top section, EMV in the middle section, and WATNA positioned at the bottom, below the EMV. The probability visualization can include a proportional display implemented by the middle section where a win probability section displays in a positive indicator color (e.g., green), a loss probability section displays in a risk indicator color (e.g., red), and sections are sized proportionally to their respective probabilities, always totaling 100%. In addition to the color scheme display preferences (e.g., green/red), the display preferences can also include value format preferences and toggle default states.

The interactive display elements can provide three toggle controls for the one or more users to modify the visual display. The toggle controls can include a “Show Present Value” toggle control which adjusts displayed values to account for the time value of money. The toggle controls can include a “Show with Adjustments” toggle which incorporates factor impact modifications. The toggle controls can include s “Show EMV with Legal Costs” toggle which includes legal cost implications.

With continued reference to FIG. 2, in some embodiments, the non-transitory computer readable media can further comprise computer program code for receiving changes to the risk data made by the one or more users (e.g., feedback loop 214 updates calculations and visualizations in real-time). Changes to the risk data are received from the one or more users via the interactive control module 114. The received changes to the risk data are processed, via the computational engine 208, using the one or more risk assessment methodologies to recalculate the risk value. An updated visual display is generated via the visualization generator 210 and displayed to the one or more users via the interactive display interface 212 based on the recalculated risk value.

In some embodiments, the system can perform real-time recalculations. Real-time recalculations can refer to the immediate updating of all dependent values and visual elements whenever input parameters change, ensuring that displayed results always reflect current inputs. Real-time concurrency can be supported by an event-driven display layer, ensuring that if a second user changes a factor from “weak” to “strong,” the probability bars and monetary values instantly update for all users. Each connected user can see the same updated display as soon as recalculations are complete. A WebSocket or push-based architecture can be used to broadcast changes.

Computational engine 208 can be configured to integrate the one or more risk assessment methodologies, for example by processing the risk data inputs through an integrated calculation framework that combines multiple risk analysis methodologies. The one or more risk assessment methodologies can comprise at least one of an expected monetary value analysis (EMV), a decision tree analysis, a best alternative to a negotiated agreement analysis (BATNA), and a worst alternative to a negotiated agreement analysis (WATNA). The multi-methodology integration results can comprise at least one of a progression from a best case-scenario to a worst case-scenario, proportional probability distributions, and monetary values. This arrangement leverages dynamic resizing, concurrency controls, and real-time graphical rendering to provide a coherent, user-friendly interface.

In some embodiments, the system can be built on a JavaScript-based front end and a Node.js (or Python) back-end server, communicating via RESTful APIs. A database (e.g., relational or NoSQL) can store case inputs, factor selections, and user credentials, ensuring versioned persistence and secure multi-user access. This technical configuration can allow real-time toggling, consistent concurrency across users, and a straightforward path for future integration with external platforms.

The unified calculation methodologies integration framework combines multiple risk analysis methodologies. A base probability determination can be made by selecting a probability scale category, for example, Very High=0.90, High=0.70, Medium=0.50, Low=0.30, and Very Low=0.10. The following equations can be used for calculating risk factor impact integration:

aP=bP+sum(imp)
Where aP represents an adjusted probability, bP represents the base probability, and imp represents factor impacts.

fP=clamp(aP,minP,maxP)
Where fP represents a final probability, aP represents the adjusted probability, minP represents a minimum probability, and maxP represents a maximum probability.

The following equations can be used for the EMV calculations:

wEMV=expG×fP
Where wEMV represents a win EMV, expG represents an expected gain, and fP represents a final probability.

lEMV=expL×(1−fP)
Where lEMV represents a loss EMV, expL represents an expected loss, and fP represents a final probability.

nEMV=wEMV+lEMV−lc
Where nEMV represents a net EMV, wEMV represents a win EMV, lEMV represents a loss EMV, and lc represents legal costs. By using concurrency-safe functions in a server-side environment (e.g., Node.js) or a stateful front-end framework, the system can recalculate these values upon every relevant toggle or factor change made by the users, then broadcast the updated results to all connected users.

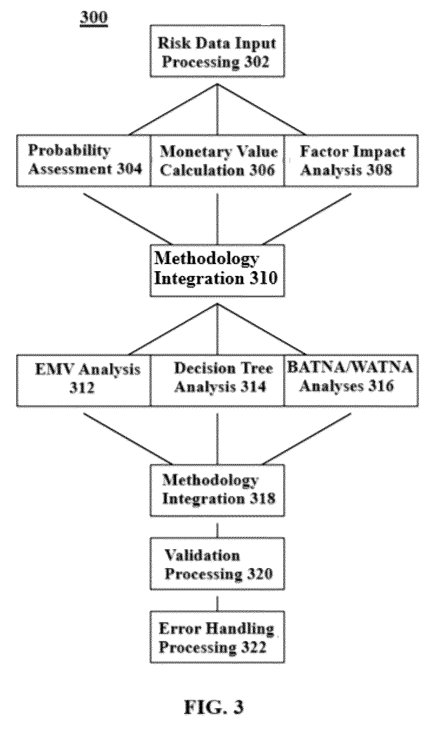

With reference to FIG. 3, a flowchart 300 detailing the calculation framework and methodology integration process (e.g. as carried out by the computational engine 108, 208) is shown. Risk data received from the one or more users is validated and processed at 302. This data is then used to perform various risk assessment methodologies. For example, probability assessment 304, monetary value calculation 306, and factor impact analysis 308. Calculations to integrate results from each of the probability assessment 304, monetary value calculation 306, and factor impact analysis 308 are performed at integration methodology step 310.

Further risk assessment methodologies including expected monetary value analysis (e.g., EMV analysis) 312, decision tree analysis 214, and best alternative to a negotiated agreement (e.g., BATNA), and a worst alternative to a negotiated agreement (e.g., WATNA) 316 analyses are performed. Final integration of all results from the various risk assessment methodologies is performed at methodology integration step 318. To ensure calculation integrity, the framework includes validation processing 320 and error handling processing 322. Error handling can include validation failure recovery, automatic state snapshots, incremental calculation checkpoints, and degraded mode operation capabilities.

Computational engine 108, 208 can implement decision tree analysis framework which integrates with EMV calculations and BATNA/WATNA boundaries. As shown in FIG. 3, the tree structure implementation includes a root node (e.g., an initial case position), primary branches including a positive outcome path (e.g., user-provided probability) and a negative outcome path (e.g., calculated inverse probability), and secondary branches including factor-influenced outcomes, cost-impact scenarios, and timeline variations.

The following decision node processing pseudocode is meant for example only and is not meant to be taken in a limiting sense.

Decision Node Processing

```
function processDecisionTree(inputs) {
  // Create primary decision node
  const rootNode = {
    batna: inputs.batna,
    watna: inputs.watna,
    baseProb: inputs.probability
  }
  // Generate factor-adjusted branches
  const branches = inputs.factors.map(factor => {
    return {
      probability: adjustProbability(rootNode.baseProb, factor),
      outcome: calculateOutcome(factor.impact),
      costs: calculateCosts(factor.timeline)
    }
  })
  // Integrate with EMV calculations
  const treeEMV = branches.reduce((acc, branch) => {
    return acc + (branch.outcome * branch.probability)
  }, 0)
  // Validate against BATNA/WATNA bounds
  return validateTreeResults(treeEMV, rootNode)
}
```

With continued reference to FIG. 3, branch probability calculation involves a primary split based on user probability (e.g., probability assessment 304). Factor impacts (e.g., factor impact analysis) modifies branch probabilities. Cumulative probability validation and branch normalization within bounds occurs throughout the decision tree integration framework. Each branch contributes to EMV calculation 306. The decision tree integration framework weighs outcomes based on branch probabilities. Cost integration is performed at relevant nodes and timeline impact is accounted for as it relates to present values.

The following methodology synchronization pseudocode is meant for example only and is not meant to be taken in a limiting sense.

Methodology Synchronization

```
function synchronizeMethodologies(tree, emv, bounds) {
  // Align tree outcomes with BATNA/WATNA
  validateBranchOutcomes(tree, bounds)
  // Synchronize probabilities
  alignProbabilities(tree.branches, emv.probability)
  // Integrate costs across methods
  const totalCosts = calculateCumulativeCosts(tree)
  applyGlobalCosts(emv, totalCosts)
  // Ensure temporal consistency
  synchronizeTimelines(tree, emv)
  return {
    treeAnalysis: tree,
    emvCalculations: emv,
    boundaryValues: bounds
  }
}
```

In some embodiments, decision tree support features can include branch comparison tools, probability sensitivity analysis, cost impact visualization, and timeline optimization suggestions. The decision tree integration framework enables comprehensive scenario analysis, factor impact visualization, cost-probability relationships, and timeline-based decision support. The decision tree analysis provides structural support for multiple outcome scenarios, factor interaction modeling, cost distribution analysis, and timeline-based branching. Each tree branch inherits properties from user-provided probabilities, factor impact designations, cost structure selections, and timeline estimates.

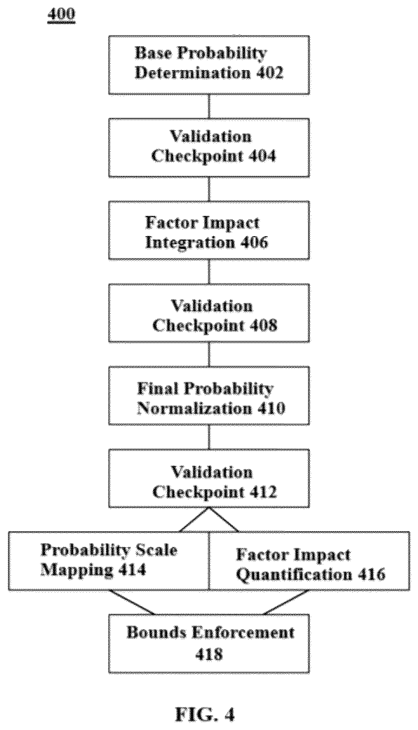

With reference to FIG. 4, a flowchart 400 detailing a probability calculation pipeline is shown. Once risk data is received from the one or more users and is validated and processed, a base probability determination 402 is carried out by the system. Next, a first validation checkpoint 404 occurs to ensure calculation accuracy and integrity. The system then performs factor impact integration at step 406, followed by a second validation checkpoint 408. A final probability normalization occurs at step 410 to integrate results from all of the multiple risk assessment methodologies, followed by a final validation checkpoint at 412. In some embodiments, probability normalization can refer to the mathematical process of adjusting calculated probabilities to ensure they remain within predefined bounds (e.g., 5% minimum to 95% maximum) while maintaining proportional relationships between different outcome scenarios. The framework includes probability scale mapping at step 414 (e.g., showing the conversion of letter grades (A-E) to numerical probabilities) and factor impact quantification at step 416 (e.g., displaying a standardized 10% adjustment mechanisms). Finally, bounds enforcement at step 418 ensures final probabilities remain within a 5%-95% range.

In certain embodiments, the non-transitory computer readable media can receive updates and adjustments to the risk data from the one or more users over time and can continuously process the updates and adjustments over time. The non-transitory computer media can further comprise computer program code for continuously processing, via the computational engine 108, 208, the proportional probability distributions from the one or more users. The non-transitory computer readable media can also comprise computer program code for continuously calculating, via the computational engine 108, 208, monetary values and continuously processing, via the computational engine 108, 208, the progression from the best case-scenario to the worst case-scenario.

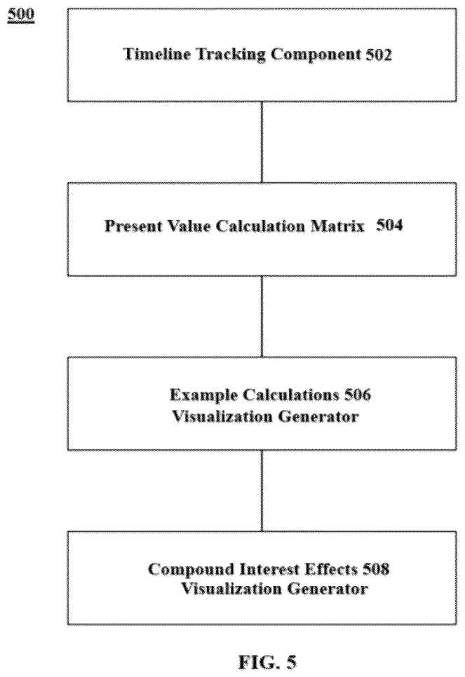

With reference to FIG. 5, a flowchart 500 showing a temporal value adjustment process through multi-stage calculations is shown. The system includes a timeline tracking component 502 which tracks temporal impact factors on a month-by-month basis. A present value calculation matrix 504 displays the relationship between time periods and temporal impact factors. Example calculations 506 are provided by the visualization generator (e.g., 210 as seen in FIG. 2). The example calculations 506 include transformations from future to present values. The visualization generator 210 also provides compound interest effects 508 based on the example calculations (e.g., visualized by decreasing value curves). The system can cache partial results so that only changes in months or discount rate re-trigger the present value calculation, improving performance in multi-user environments.

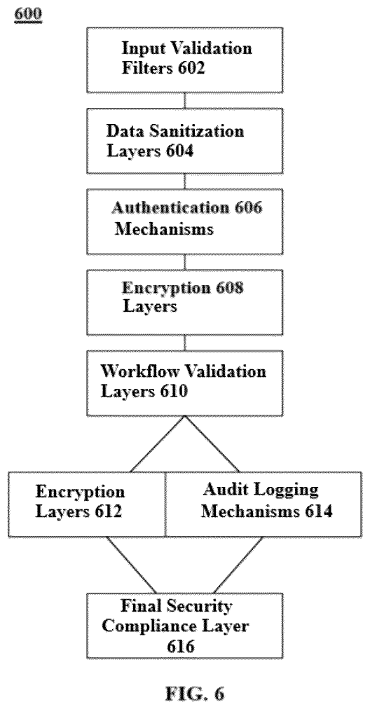

With reference to FIG. 6, a security and validation framework 600 is shown. FIG. 6 shows layer security components including input validation filters 602, data sanitization layers 604, authentication mechanisms 606, and encryption layers 608. The validation workflow framework 600 demonstrates how BATNA/WATNA consistency checks, probability bounds validation, and temporal parameter verification are implemented by the system. Connection points between security layers (e.g., input validation filters 602, data sanitization layers 604, authentication mechanisms 606, and encryption layers 608) are detailed with encryption layers 612 and audit logging mechanisms 614. The system also includes a final security compliance layer 616.

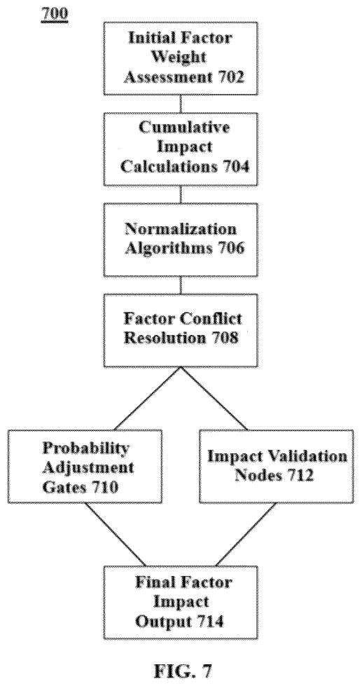

With reference to FIG. 7, a flowchart 700 demonstrating a risk factor impact integration workflow is shown. The risk factor integration workflow illustrates how each risk factor's strong/weak/neutral designation is processed. For example, an initial factor weight assessment occurs at step 702, followed by cumulative impact calculations at 704, processing of normalization algorithms at 706, and factor conflict resolution at 708. The workflow further includes probabilistic adjustment gates 710 and impact verification nodes 712. Finally, a final factor impact output is processed at 714.

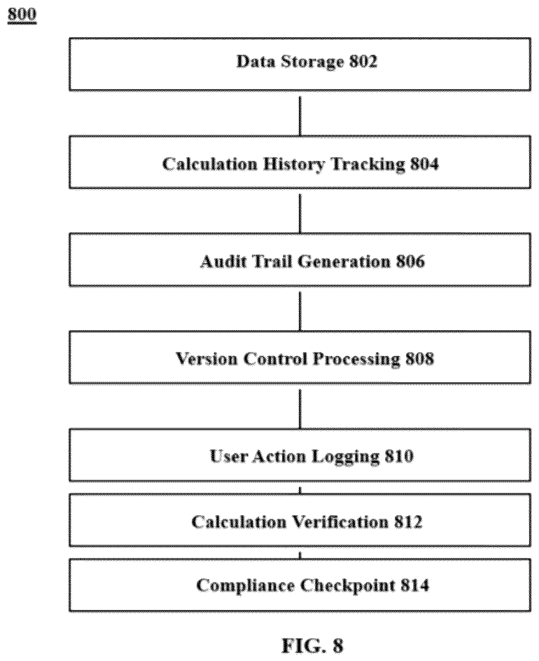

With reference to FIG. 8, a data persistence and audit architecture 800 is shown. In some embodiments, the non-transitory computer readable media can further comprise computer program code for storing risk analysis history data. The risk analysis history data can comprise updates to the risk data made by the one or more users and calculation logs over time. The risk analysis history data can be stored in data storage 802 (e.g., shown in FIG. 1 data storage 110). The system is further configured for calculation history tracking 804 and audit trail generation 806. The data persistence and audit architecture further include version control mechanisms 808 to track changes relating to probability adjustments and risk factor impacts. The audit framework includes user action logging 810, calculation verification 812, and compliance checkpoints 814. The system can store compliance logs, audit trails, user activity histories, and security verification records.

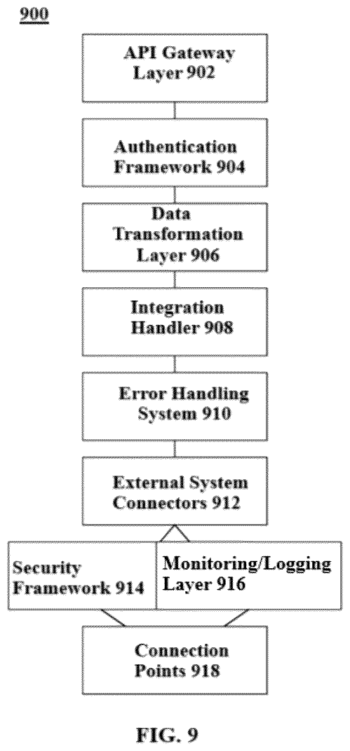

With reference to FIG. 9, an API integration framework 900 is shown. The API integration framework details the system's external communication architecture. The API integration framework comprises an API gateway layer 902, authentication framework 904, data transformation layer 906, integration handler 908, error handling system 910, external system connectors 912, security framework 914, monitoring and logging layers 916, and connection points 918. The API gateway layer 902 can include rate limiting and throttling controls, request validation and sanitization, API version management, and load balancing distribution. The authentication framework 904 can include OAuth 2.0 implementation, JWT (JSON Web Token) handling, API key management, and role-based access control.

The data transformation layer 906 can include request/response payload mapping, data format standardization, schema validation, and content negotiation handling. The integration handler 908 can include REST endpoint implementations, GraphQL query resolution, WebSocket connection management, and gRPC service definitions. The error handling system 910 can include HTTP status code mapping, custom error response formatting, retry mechanism configuration, and circuit breaker implementations. The external system connectors 912 can include case management systems adapters, document management interfaces, analytics platform integration, and third-party API clients. Security framework 914 can include TLS/SSI encryption, API request signing, IP whitelisting, and rate limit enforcement. Monitoring and logging layer 916 can include API usage metrics, performance monitoring, error tracking, and audit logging.

The API integration framework implements standardized data exchange patterns through data exchange protocols, integration patterns, the data transformation layer 906, the external system connectors 912, the security framework 914, and error recovery through error handling system 910. The following data exchange protocol pseudo code is meant for example only and is not meant to be taken in a limiting sense.

Data Exchange Protocols

```
interface ExternalSystemIntegration {
  // Standardized data ingestion
  async function importExternalData(source, type) {
      const rawData = awaitfetchExternalData(source)
      const validated = validateDataSchema(rawData, type)
      return transformToInternalFormat(validated)
  }
  // Normalized data export
  async function exportAnalysis(destination, format) {
    const analysis = await prepareExportData( )
    const transformed = applyExportFormat(analysis, format)
    return secureTransmit(transformed, destination)
  }
}
```

Integration patterns can include synchronous and asynchronous operations. Synchronous operations can include REST-based CRUD operations, direct query interfaces, immediate response handling, and validation feedback loops. A synchronous operations can include event-driven updates, webhook notifications, background processing, and batch operations.

The data transformation layer 906 can be enhanced with schema mapping and format conversion. Schema mapping can include dynamic field mapping, data type conversion, null value handling, and validation rules. Format conversion includes J SON/XML transformation, binary data handling, character encoding, and compression handling.

The external system connectors 912 can be expanded with case management integration and analytics platform connection. Case management integration can include matter information synchronization, document reference linking, timeline coordination, and cost tracking alignment. Analytics platform connection can include jurisdiction data importing, outcome statistics synchronization, trend analysis integration, predictive modelling sharing, external case law data, historical settlement information, and legal precedent analysis.

The security framework 914 is enhanced with data classification and transmission security. Data classification includes PII handling rules, confidentiality levels, access control matrices, and audit requirements. Transmission security includes end-to-end encryption, certificate management, key rotation policies, and protocol enforcement.

The enhanced API integration framework enables seamless third-part integration, robust data synchronization, secure information exchange, and reliable error recovery. The API integration system maintains data integrity, system independence, security compliance, and performance optimization.

The above described systems and methods provide a comprehensive error handling framework. The error handling framework includes validation failure handling. Validation failure handling provides immediate user feedback through UI indicators and suggested corrections based on validation rules. Invalid states can be stored temporarily for recovery purposes. When deterministic rules apply, the validation failure handling framework can provide automatic correction. The error handling framework further provides data consistency enforcement. For example, ensuring BATNA>WATNA with automatic adjustment suggestions, probability bounds enforcement (e.g., 5%-95%), factor impact normalization, and temporal consistency checks.

Additionally, the error handling and recovery framework can provide recovery procedures, for example, automatic state snapshots before significant changes, rolling transaction logs for audit and recovery, user session persistence across connection failures, and incremental save points for complex calculations. The error handling and recovery framework can also provide fallback mechanisms, for example, degraded mode operation during connectivity issues, local calculation cache with sync markers, automatic retry with exponential backoff, and manual override capabilities for critical operations.

The following error handling pseudocode is meant for example only and is not meant to be taken in a limiting sense.

Error Recovery

```
class IntegrationErrorHandler {
    async handleConnectionFailure(error) {
      // Implement retry with exponential backoff
    const retryResult = await exponentialRetry(error.operation)
    // Cache failed operations for recovery
    if (!retryResult.success) {
      await cacheForRecovery(error.operation)
      initiateFailoverProcess(error.context)
    }
    // Notify relevant systems
    await notifySystemStatus(error.status)
  }
}
```

In certain other embodiments, the non-transitory computer readable media can further comprise computer program code for generating one or more targeted questions for the one or more users to answer. The one or more targeted questions can capture essential risk factors and case specific parameters. The non-transitory computer readable media can further comprise computer program code for receiving answers from the one or more users relating to the one or more targeted questions. The answers can comprise data (e.g., risk data) relating to at least one of a maximum gain assessment, a maximum loss assessment, a most likely win amount, a most likely loss amount, probability assessment, a legal cost estimation, a time estimation, and case-specific factors.

The probability assessment can comprise a multi-level probability scale for assessing likelihood of a given risk factor. The case-specific factors can comprise at least one of documentary evidence, witness testimony and availability, legal precedents, expert opinions, and opposition's case strength. Each of the case-specific factors can be designated as strong, weak, or not applicable by the one or more users.

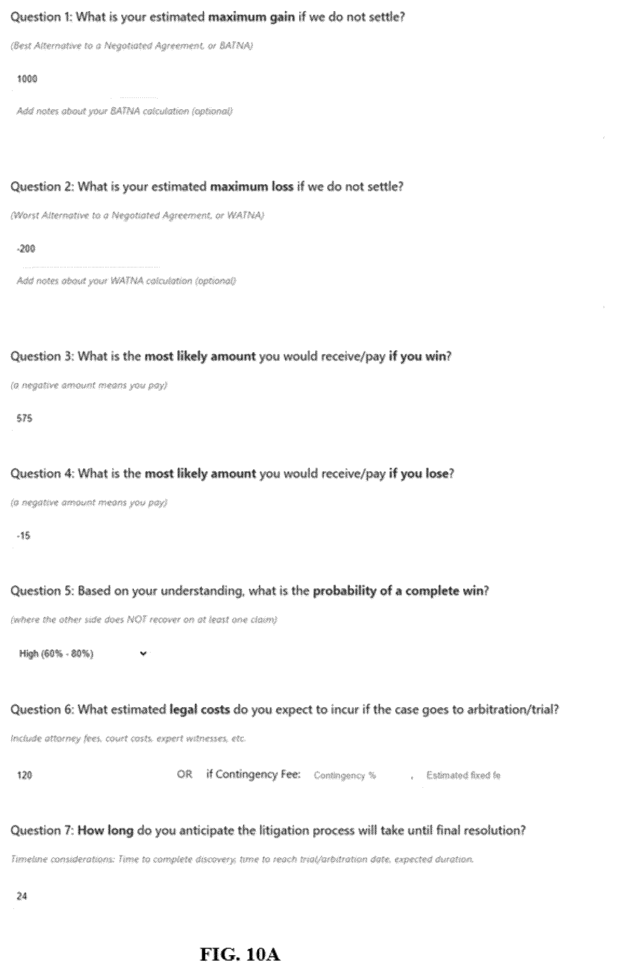

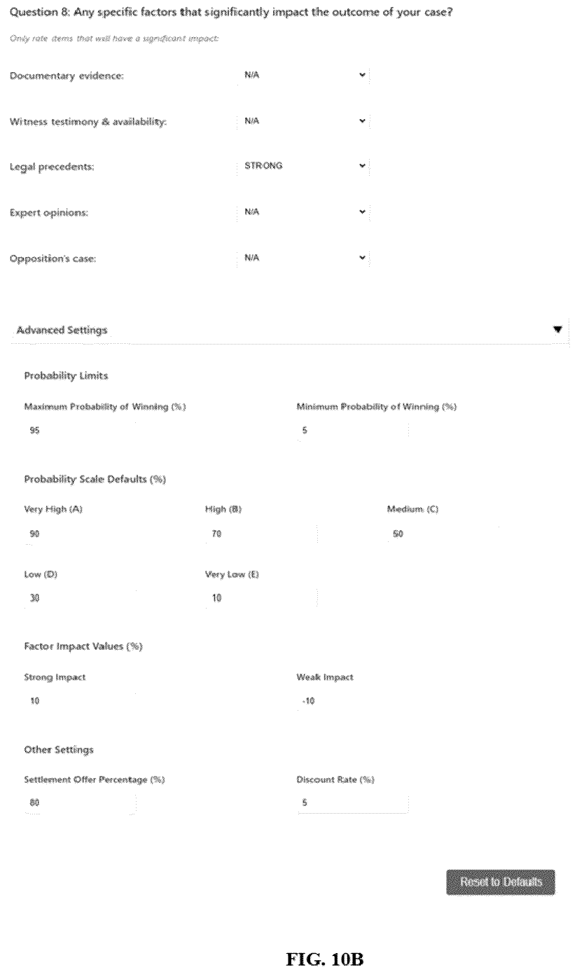

With reference to FIGS. 10A, an exemplary user input interface is shown. The exemplary user input interface includes a series of eight targeted questions to be filled out by the one or more users and a five-level probability selection system. The interface includes labeled input fields for BATNA value, WATNA value, expected gain, and expected loss. The probability selection component (e.g., probability of a complete win) displays the five-level scale with corresponding percentage ranges (as shown in FIG. 10A, “high level 60-80%” is selected). Legal cost input fields can accommodate both standard and contingency fee structures. A timeline estimation field allows users to input the expected duration of the dispute resolution in months. The case-specific factors section provides access to the factor impact selection interface (e.g., as shown in FIG. 10B).

With reference to FIG. 10B, the factor impact selection interface with its standardized strong/weak/neutral designation system is shown. The interface displays five key factors arranged vertically including documentary evidence, witness testimony and availability, legal precedents, expert opinions, and opposition's case strength. Each factor includes three selection options including strong, weak, and N/A (neutral). A factor impact summary panel displays the cumulative probability adjustment, with a probability bounds indicator (e.g., probability limits) showing the 5% minimum and 95% maximum limits. Interactive tooltips provide guidance for each factor's evaluation criteria. A user can also adjust probability scale defaults, factor impact values, settlement offer percentage, and discount rate. A reset control allows users to clear all factor designations.

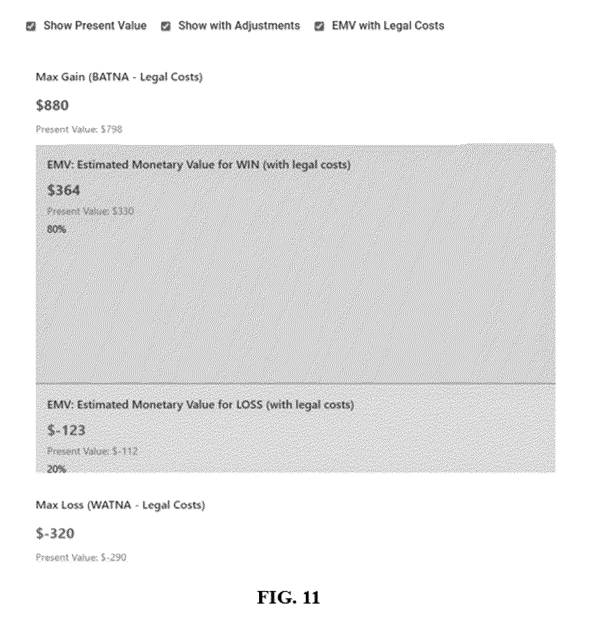

With reference to FIG. 11, an exemplary unified visual display showing the progression from BATNA to WATNA with integrated probability representations is shown. The display is vertically organized with the BATNA section at the top, containing the maximum potential gain value and associated notes. The middle section shows EMV with proportionally sized probability segments (e.g., a green-shaded win probability top section and a red-shaded loss probability bottom section). The WATNA section appears below the EMV section and displays the maximum potential loss value. Interactive toggle controls enable users to switch between different views, for example, present value, factor adjustments, and legal cost views. A settlement recommendation band indicates the calculated settlement range based on the adjusted EMV.

With continued reference to FIG. 11, three primary toggle controls are shown (e.g., “Show Present Value” toggle with associated year/month timeline indicators, “Show with Adjustments” toggle displaying factor impact modifications, and “Show EMV with Legal Costs” toggle incorporating fee structures). Each toggle can have inactive and active states, demonstrating how the interface elements change. A preview panel can show real-time updates as toggles are activated, and a coordinated legend can explain the visual changes. A settings panel can allow customization of toggle behaviors, including default states and transition animations.

In some embodiments, with respect to the visual representation (e.g., as shown in FIG. 11), the branch thickness can indicate probability, the node size can reflect monetary value, and color coding can be used to demonstrate outcome type. In some embodiments, the visual representation can include interactive branch exploring (e.g., via toggles),

The systems and methods as described herein can further include a methodology integration framework which achieves unified risk analysis through a vertical integration approach that combines multiple methodologies (e.g., via computational engine) into a single coherent framework (e.g., which is generated via the visualization generator and displayed to the one or more users via the interactive displayed interface). The methodology integration framework can include vertical scale integration (e.g., as shown in FIG. 11). The vertical scale integration can display BATNA at the top (e.g., 100% of the vertical space), WATNA positioned at the bottom (e.g., 0% of the vertical space), intermediate values mapped proportionally between endpoints, and a visual progression reflecting probability-weighted positions.

The methodology integration framework can also include a scale structure, where the top (e.g., 100% is the best case (e.g., BATNA), the middle section is the EMV probability distribution, and the bottom (e.g., 0%) is the worst case (e.g., WATNA)). The upper portion of the middle section includes EMV of positive outcome probability and the lower portion of the middle section includes the EMV of negative outcomes probability.

The methodology integration framework can provide visual distribution, for example, EMV section height proportional to total display height, positive outcome portion sized by user-provided probability, negative outcome portion sized by calculated inverse probability, and clear visual separation between positive/negative sections. The methodology integration framework can provide dynamic updates, for example, probability adjustments can immediately resize sections, factor impacts can modify probability distribution, real-time recalculation of EMV positions, and smooth transitions between states. This unified approach provides an intuitive visual representation where the total probability always equals 100%, positive and negative outcomes are clearly delineated, EMV calculations reflect current probability distribution, and BATNA and WATNA provide fixed reference points.

The systems and methods as described herein implement a structured approach to generate an output (e.g., through the visual representation), including settlement recommendations, based on the multiple analytical inputs. The following pseudocode is meant for exemplary purposes only and is not meant to be taken in a limiting sense.

Settlement Range Calculation

```
function calculateSettlementRange(inputs) {
  // Calculate core EMV-based recommendation
  const baseEMV = calculateEMV(inputs)
  // Apply confidence adjustments
  const confidenceInterval = {
    upper: baseEMV + (baseEMV * CONFIDENCE_MARGIN),
    lower: baseEMV − (baseEMV * CONFIDENCE_MARGIN)
  }
  // Factor timeline impact
  const timeAdjusted = applyTimeValueDiscount(confidenceInterval, inputs.timeline)
  // Integrate legal costs
  const costAdjusted = incorporateLegalCosts(timeAdjusted, inputs.costs)
  // Validate against BATNA/WATNA bounds
  return clampToLimits(costAdjusted, inputs.batna, inputs.watna)
}
```

The criteria for the settlement recommendations can include primary factors, for example, EMV calculations, probability-weighted outcomes, legal cost projections, and time value of money and secondary factors, for example, factor impact strengths, jurisdiction patterns, case type statistics, and risk tolerance levels. A settlement range determination process can include calculating a core settlement value. The core settlement value can be calculated from an adjusted EMV and weighted probability distribution and can be normalized against the probability bounds. Range boundaries can also be calculated by the system. For example, an upper limit (e.g., min (BATNA, EMV+confidence_margin)), a lower limit (e.g., max (WATNA, EMV−confidence_margin)), and a confidence margin (e.g., typically 15-20% of EMV).

Dynamic adjustments made by users can cause settlement recommendations to be adjusted. The dynamic adjustments can include time-based modifications, for example, present value calculations, litigation timeline impact, and cost escalation factors. The dynamic adjustments can also include risk-based modifications, for example, probability confidence, factor impact strengths, and jurisdiction considerations.

In some embodiments, a recommendation display can include visual elements and interactive features. Visual elements can include a settlement range band, an optimal settlement point, confidence indicators, and risk exposure markers. Interactive features can include range adjustment tools, scenario comparisons, timeline impact visualizations, and cost sensitivity analyses.

The settlement recommendation outputs can be verified through validation checks. Validation checks can include confirming BATNA values exceed WATNA values, verifying logical consistency of probability selections, validating temporal parameters, and ensuring cost input rationality. The following pseudo code is meant for exemplary purposes only and is not meant to be taken in a limiting sense.

Validation Checks

```
function validateRecommendation(recommendation, bounds) {
  // Ensure recommendation falls within BATNA/WATNA bounds
  if (recommendation.value > bounds.batna ∥
      recommendation.value < bounds.watna) {
    return adjustToBounds(recommendation, bounds)
  }
  // Verify range spread is reasonable
  if (recommendation.range > MAX_RANGE_SPREAD) {
    return normalizeRange(recommendation)
  }
  // Check timeline feasibility
  if (!isTimelineRealistic(recommendation.timeline)) {
    return adjustForTimeline(recommendation)
  }
  return recommendation
}
```

The settlement recommendation framework provides data-driven settlement guidance, risk-adjusted recommendations, timeline-sensitive valuations, and cost-aware decision support. Settlement recommendations are presented with clear value ranges, confidence indicators, risk exposure metrics, and adjustment rationales.

The above described systems and methods implement a comprehensive approach to incorporate legal costs into the risk analysis calculations (e.g., as shown in FIG. 5). The following pseudocode is meant for example only and is not meant to be taken in a limiting sense.

Cost Structure Processing

```
function processLegalCosts(inputs) {
  const costs = {
    // Handle hourly billing structure
    hourly: {
      rate: inputs.hourlyRate,
      estimatedHours: inputs.projectedHours,
      contingencies: inputs.timeContingencies
    },
    // Handle contingency fee structure
    contingency: {
      percentage: inputs.contingencyRate,
      applicableAmount: determineApplicableAmount(inputs),
      exclusions: inputs.contingencyExclusions
    },
    // Handle fixed costs
    fixed: {
      courtFees: inputs.courtCosts,
      expertFees: inputs.expertCosts,
      adminCosts: inputs.administrativeCosts
    }
  }
  return calculateTotalCosts(costs, inputs.timeline)
}
```

The cost calculations methods can include hourly fee calculation, contingency fee calculation, and fixed cost integration. An hourly fee calculation can be calculated based on a number of base hours times an hourly rate. The hourly fee calculation can further include complexity multipliers, time-line based escalators, and volume discounts. A contingency fee calculation can be based on a percentage of recovery, staged percentage adjustments, cost responsibility allocation, and recovery thresholds. A fixed cost integration calculation can include court filing fees, expert witness costs, administrative expenses, and third-party charges.

The above described systems and methods can include timeline impact processing (e.g., as shown in FIG. 5). The following pseudocode is meant for example only and is not meant to be taken in a limiting sense.

Timeline Impact Processing

```
function calculateTimelineImpact(costs, timeline) {
  // Apply time-based cost escalation
  const escalationRate = ANNUAL_COST_INCREASE
  const timelineYears = timeline / 12
  // Calculate present value of future costs
  return Object.entries(costs).map(([type, amount]) => {
    return {
      type,
      presentValue: amount / Math.pow(1 + DISCOUNT_RATE, timelineYears),
      escalatedValue: amount * Math.pow(1 + escalationRate, timelineYears)
    }
  })
}
```

The EMV cost integration can include cost allocation and probability weighting. Cost allocation can be based on win scenario costs, loss scenario costs, fixed cost distribution, and timeline based adjustments. Probability weighting can be based on cost certainty factors, scenario-specific allocations, risk-adjusted cost estimates, and confidence intervals.

The visual display integration can include toggle functionality and cost impact visualization. The toggle functionality can allow the one or more users to show/hide cost impact, view a cost breakdown, view a timeline cost progression, and view comparative cost scenarios. Cost impact visualization can include color-coded cost categories, cost proportion indicators, timeline-based cost curves, and threshold markers.

The cost validation framework pseudocode is provided for example only and is not meant to be taken in a limiting sense.

Cost Validation Framework

```
function validateCostStructure(costs, bounds) {
  // Ensure costs don't exceed case value
  if (costs.total > bounds.caseValue * MAX_COST_RATIO) {
    return flagExcessiveCosts(costs)
  }
  // Validate cost timeline alignment
  if (!isTimelineConsistent(costs.timeline, bounds.caseTimeline)) {
    return adjustTimelineAlignment(costs, bounds)
  }
  // Check cost structure compatibility
  if (!areStructuresCompatible(costs.structure, bounds.caseType)) {
    return suggestAlternativeStructure(costs, bounds)
  }
  return costs
}
```

The cost validation framework provides accurate cost projections, structure-specific calculations, timeline-sensitive adjustments, and risk-weighted cost analysis. The legal cost integration provides transparent cost visibility, structure flexibility, timeline adaptation, and EMV cost incorporation.

The components and architectures of the system as described herein support real-time concurrency and event-driven updates. The system caches partial computations so that only changed factors or toggles trigger a recalculation in the multi-methodology calculation engine, ensuring minimal latency and smoother user interaction. The system implements a robust concurrency management framework comprising an optimistic locking mechanism, a conflict resolution protocol, and real-time synchronization. The optimistic locking mechanism allows each data object (e.g., risk data inputted by users) to maintain a version counter and allows user updates to increment the version counter. Through the optimistic locking mechanism, concurrent modifications made by users (e.g., to the risk data) are detected through version mismatches. Failed updates trigger automatic retry provided by the conflict resolution protocol.

The conflict resolution protocol provides last-write-wins for non-critical updates and three-way merge for compatible changes. The conflict resolution protocol is also configured to provide user notification and manual resolution for conflicting critical changes. The conflict resolution protocol further provides automatic state rollback capabilities. Real-time synchronization includes WebSocket-based push notifications, event sourcing for change tracking, message queue for update serialization, and heartbeat mechanism for connection health monitoring.

The systems and methods as described herein can include a simplified user input system. The one or more users can input answers relating to eight targeted core questions (e.g., see FIGS. 10A and 10B) relating to maximum gain assessment (e.g., BATNA), maximum loss assessment (e.g., WATNA), most likely win amount, most likely loss amount, probability assessment, legal costs, time estimation and case specific factors. The maximum gain assessment filed can prompt users to input their best alternative to a negotiated agreement, representing the maximum potential gain in a complete-win scenario. This value establishes the upper boundary of the analysis framework. The maximum loss assessment field can prompt users to input their worst alternative to a negotiated agreement, representing the maximum potential loss. This value establishes the lower boundary of the analysis framework.

The most likely win amount field can allow the system to collect the most probable positive outcome amount, distinguishing between the theoretical maximum and the realistically expected gain (e.g., expected by the users). The most likely loss amount filed can allow users to input the most probable negative outcome amount, providing a realistic assessment of potential losses distinct from the worst-case scenario.

A probability assessment field can allow the system to implement a five-level probability scale for assessing the likelihood of a complete win. The five level probability scale can include the following levels: very high (e.g., 80%-100%), high (e.g., 60%-80%), medium (e.g., 40%-60%), low (e.g., 20%-40%), and very low (e.g., 0%-20%). This simplified probability assessment system provides significant improvements over traditional percentage-based inputs by reducing cognitive load while maintaining analytical accuracy.

A legal costs field can allow users to specify standard hourly or contingency fee structures, so the system can incorporate these costs into overall analysis. A time estimation field can allow the system to collect an estimated timeline to resolution, expressed in months, which is used for present value discounting. A case-specific factors field can aggregate selections for users relating to documentary evidence, witness testimony, legal precedents, expert opinions, and opposition case strength. A concurrency flag can be enabled if multiple users plan to access these inputs simultaneously, ensuring that all user edits are tracked in real-time.

In some embodiments, the five case-specific factors can be designated as strong (e.g., positive 10% probability adjustment), weak (e.g., negative 10% probability adjustment), or N/A (e.g., no probability adjustment). The factor impact system can include independent evaluation of each factor, cumulative impact calculation, probability normalization, and dynamic visual updates. The factor impact system can include a standardized adjustment mechanism, interactive adjustment controls, and cumulative impact management. The standardized adjustment mechanism can cause the system to apply a consistent 10% modification to the base probability for each factor, with the direction determined by the strong/weak designation (e.g., positive or negative). This standardization simplifies the adjustment process while maintaining meaningful impact assessment.

The interactive adjustment controls can allow users to modify the standard 10% adjustment value through advanced settings, allowing customization while maintaining the simplified strong/weak designation system. The cumulative impact management can allow the system to implement probability bounds (e.g., minimum 5%, maximum 95%) to ensure realistic final probabilities regardless of the number of factors applied. The adjustment controls can also include an adjustable discount rate (e.g., 0.05%) and adjustable strong/weak designations for factor impacts (e.g., 0.10 and −0.10).

In the event of multiple strong and weak designations conflicting (e.g., four strong vs. two weak), the system aggregates them linearly and applies a final normalization step that clamps the outcome within the 5%-95% range. This process ensures no extreme overshadowing by numerous strong or weak factors. For example, a base probability (from scale) is 0.70 (High), there are four strong factors +0.40 cumulative, two weak factors −0.20 cumulative, making the net equal 0.70+0.20=0.90. In this case, normalization clamp is 0.90 and is within 0.95 upper bound, so final probability is 0.90 If the net sum exceeded 0.95, the system would clamp it at 0.95.

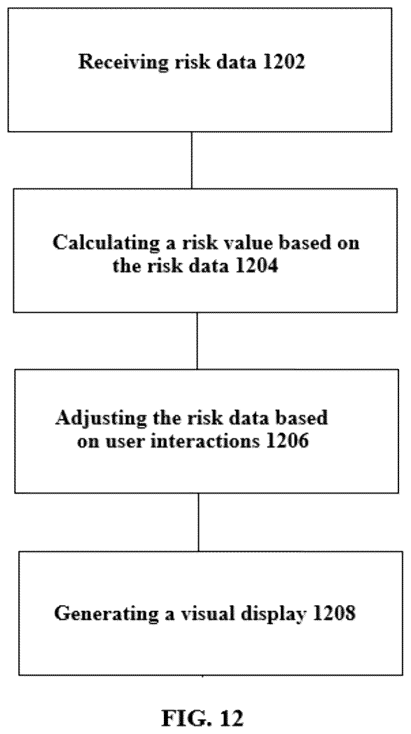

With reference to FIG. 12, the present invention provides a method for legal risk analysis. According to an embodiment, a computer-implemented method for legal risk analysis comprises receiving risk data 1202 from one or more users via a user interface over a communication network and calculating a risk value based on the risk data 1204 using one or more risk assessment methodologies. The method further comprises continuously adjusting the risk data based on interactions from the one or more users 1206 and generating a visual display 1208 comprising multi-methodology integration results from the one or more risk assessment methodologies.

The one or more risk assessment methodologies can comprise at least one of an expected monetary value analysis, a decision tree analysis, a best alternative to a negotiated agreement and a worst alternative to a negotiated agreement analysis. The multi-methodology integration results can comprise at least one of a progression from a best case-scenario to a worst case-scenario, proportional probability distributions, and monetary values.

In some embodiments, the method can further comprise continuously processing, via the computational engine, the proportional probability distributions from the one or more users, continuously calculating, via the computational engine, monetary values, and continuously processing, via the computational engine, the progression from the best case-scenario to the worst case-scenario. The method can further comprise generating one or more targeted questions for the one or more users relating to the risk data and receiving answers to the one or more targeted questions from the one or more users. The answers can comprise data relating to at least one of a maximum gain assessment, a maximum loss assessment, a most likely win amount, a most likely loss amount, probability assessment, a legal cost estimation, a time estimation, and case specific factors.

In certain embodiments the probability assessment can comprise a multi-level probability scale for assessing likelihood of a given risk factor. The case specific factors can comprise at least one of documentary evidence, witness testimony and availability, legal precedents, expert opinions, and opposition's case strength. Each of the case specific factors can be updated based on a percentage modification for each of the case specific factors, such as a default value of 10% modification that may be modified for a given factor or scenario.

In some embodiments, the method can further comprise storing risk analysis history data. The risk analysis history data can comprise updates to the risk data made by the one or more users and calculation logs over time.

In some embodiments, the system architecture can support multiple concurrent users at once. The system architecture can provide session persistence, data export capabilities, and report generation capabilities. For example, data can be exported to external platforms such as third-party legal risk platforms, case management software, litigation analytics tools, external data sources, law firms, courts systems, and the like. Report generation can include using the data and risk analysis results for detailed risk reports, for example, exportable analysis reports, comparative scenario analyses, settlement range recommendations, and risk-adjusted monetary value calculations.

In some embodiments, the system architecture provides security measures such as input validation, data sanitization, session management, and access controls. Security features can further include protecting input data confidentiality, validation of user access, secure calculation processes, and safeguarding analysis results. The system can support future enhancements through a modular component architecture, configurable calculation parameters, customizable visual elements, and API integration capabilities.

The following example is meant for exemplary purposes only and is not meant to be taken in a limiting sense. Consider a legal dispute over an alleged breach of contract with a potential maximum gain of $1,000,000 (e.g., BATNA) and a worst-case scenario of $250,000 in damages (e.g., WATNA). The user assigns the probability category “High,” corresponding to a 70% base probability, and identifies “Documentary Evidence” and “Legal Precedents” as strong (+10% each), while “Opposition's Case Strength” is weak (−10%). A timeline of 12 months is entered with a discount rate of 5% is applied.

Upon confirming these above inputs, the system makes the following calculations. Adjusted Probability is calculated by the following 0.70+ (0.10+0.10−0.10)=0.80. Clamped Probability is 0.80 (e.g., within 5%-95% range). Present Value of potential is $1,000,000 after 1 year at 5%≈$952,381. Win EMV≈0.80×$952,381=$761,905 (e.g., ignoring legal costs for simplicity). Loss EMV (e.g., assuming $250,000 WATNA)≈0.20×(−$250,000)=−$50,000. Net EMV is $711,905. Real-time toggling “Show EMV with Legal Costs” adjusts this total to subtract the user-defined legal fees, and all connected team members see the update immediately.

In some embodiments, user devices can comprise computing devices (e.g., desktop computers, terminals, laptops, personal digital assistants (PDA), cellular phones, smartphones, tablet computers, or any computing device having a central processing unit and memory unit capable of connecting to a network). User devices can also comprise a graphical user interface (GUI) or a browser application provided on a display (e.g., monitor screen, LCD or LED display, projector, etc.).

The user devices can vary in terms of capabilities or features. For example, a web-enabled client device, which may include one or more physical or virtual keyboards, mass storage, or a display with a high degree of functionality, such as a touch-sensitive color 2D or 3D display. User devices can also include or execute an application to communicate content, such as, for example, textual content, multimedia content, or the like. The user devices can also include or execute an application to perform a variety of possible tasks, such as browsing and searching.

User devices can include or execute a variety of operating systems, including a personal computer operating system, such as a Windows, Mac OS or Linux, or a mobile operating system, such as IOS, Android, or Windows Phone, or the like. The user devices can include or may execute a variety of possible applications, such as a client software application enabling communication with other devices, such as communicating one or more messages, such as via email, short message service (SMS), multimedia message service (MMS), or messages on social network platforms including, for example, Facebook, LinkedIn, Twitter, Pinterest, Snapchat, or Instagram, to provide only a few possible examples.

In some embodiments, the communication network can be any suitable type of network allowing transport of data communications across thereof. The communication network can couple devices so that communications may be exchanged, such as between servers and user devices or other types of devices, including between wireless devices coupled via a wireless network, for example. Communication network can also include mass storage, such as network attached storage (NAS), a storage area network (SAN), cloud computing and storage, or other forms of computer or machine readable media, for example. In one embodiment, the communication network may be the Internet, following known Internet protocols for data communication, or any other communication network, e.g., any local area network (LAN) or wide area network (WAN) connection, cellular network, wire-line type connections, wireless type connections, or any combination thereof.

Communications and content stored and/or transmitted to and from user devices may be encrypted using, for example, the Advanced Encryption Standard (AES) with a 128, 192, or 256-bit key size, or any other encryption standard known in the art.

In some embodiments, the system may vary widely in configuration or capabilities but can be comprised of at least a special-purpose digital computing device including at least one or more central processing units and memory. The system can also include one or more of mass storage devices, power supplies, wired or wireless network interfaces, input/output interfaces, and operating systems, such as Windows Server, Mac OS X, Unix, Linux, FreeBSD, or the like. In an example embodiment, the system can include or have access to memory for storing instructions or applications for the performance of various functions and a corresponding processor for executing stored instructions or applications. For example, the memory may store an instance of the server configured to operate in accordance with the disclosed embodiments. The system can be operative to receive requests from user devices 102 and process the requests to generate results to the user devices across the communication network.

According to one embodiment, one or more components within the system may communicate with each other via a communications interface, bus, or channel. Alternatively, one or more components may be software loaded in various memory devices or locations and executed via one or more processors or processing cores. Secured encryption communication.

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. Non-transitory computer readable media comprising computer program code that when executed by a programmable processor causes execution of a method performed by a computer system for automatically generating and displaying risk assessment results to more efficiently process risk, the non-transitory computer readable media comprising:
computer program code for receiving risk data from one or more users via a user interface over a communication network;
computer program code for processing, via a computational engine, the risk data using one or more risk assessment methodologies to calculate a risk value; and
computer program code for generating a visual display comprising multi-methodology integration results from the one or more risk assessment methodologies.

2. The non-transitory computer readable media of claim 1, further comprising:
computer program code for receiving changes to the risk data made by the one or more users via an interactive control module;
computer program code for processing, via the computational engine, the received changes to the risk data using the one or more risk assessment methodologies to recalculate the risk value; and
computer program code for generating an updated visual display based on the recalculated risk value.

3. The non-transitory computer readable media of claim 1, wherein the computational engine is configured to integrate the one or more risk assessment methodologies, the one or more risk assessment methodologies comprising at least one of an expected monetary value analysis, a decision tree analysis, a best alternative to a negotiated agreement analysis, and a worst alternative to a negotiated agreement analysis.

4. The non-transitory computer-readable media of claim 1, wherein the multi-methodology integration results comprise at least one of a progression from a best case-scenario to a worst case-scenario, proportional probability distributions, and monetary values.

5. The non-transitory computer readable media of claim 4, further comprising computer program code for continuously:
processing, via the computational engine, the proportional probability distributions from the one or more users;
calculating, via the computational engine, monetary values; and
processing, via the computational engine, the progression from the best case-scenario to the worst case-scenario.

6. The non-transitory computer readable media of claim 1, further comprising computer program code for generating one or more targeted questions for the one or more users to answer, the one or more targeted questions capturing essential risk factors and case specific parameters.

7. The non-transitory computer readable media of claim 6, further comprising computer program code for receiving answers from the one or more users relating to the one or more targeted questions, the answers comprising data relating to at least one of a maximum gain assessment, a maximum loss assessment, a most likely win amount, a most likely loss amount, probability assessment, a legal cost estimation, a time estimation, and case specific factors.

8. The non-transitory computer readable media of claim 7, wherein the probability assessment comprises a multi-level probability scale for assessing likelihood of a given risk factor.

9. The non-transitory computer readable media of claim 7, wherein the case specific factors comprise at least one of documentary evidence, witness testimony and availability, legal precedents, expert opinions, and opposition's case strength.

10. The non-transitory computer readable media of claim 9, wherein each of the case specific factors is designated as strong, weak, or not applicable by the one or more users.

11. The non-transitory computer readable media of claim 1, further comprising computer program code for storing risk analysis history data, the risk analysis history data comprising updates to the risk data made by the one or more users and calculation logs over time.

12. A computer-implemented method for legal risk analysis, comprising:
receiving risk data from one or more users via a user interface over a communication network;
calculating a risk value based on the risk data using one or more risk assessment methodologies;
continuously adjusting the risk data based on interactions from the one or more users; and
generating a visual display comprising multi-methodology integration results from the one or more risk assessment methodologies.

13. The method of claim 12, wherein the one or more risk assessment methodologies comprise at least one of an expected monetary value analysis, a decision tree analysis, a best alternative to a negotiated agreement and a worst alternative to a negotiated agreement analysis.

14. The method of claim 12, wherein the multi-methodology integration results comprise at least one of a progression from a best case-scenario to a worst case-scenario, proportional probability distributions, and monetary values.

15. The method of claim 14, further comprising continuously:
processing, via the computational engine, the proportional probability distributions from the one or more users;
calculating, via the computational engine, monetary values; and
processing, via the computational engine, the progression from the best case-scenario to the worst case-scenario.

16. The method of claim 12, further comprising:
generating one or more targeted questions for the one or more users relating to the risk data; and
receiving answers to the one or more targeted questions from the one or more users, the answers comprising data relating to at least one of a maximum gain assessment, a maximum loss assessment, a most likely win amount, a most likely loss amount, probability assessment, a legal cost estimation, a time estimation, and case specific factors.

17. The method of claim 16, wherein the probability assessment comprises a multi-level probability scale for assessing likelihood of a given risk factor.

18. The method of claim 16, wherein the case specific factors comprise at least one of documentary evidence, witness testimony and availability, legal precedents, expert opinions, and opposition's case strength.

19. The method of claim 16, wherein each of the case specific factors are updated based on a percentage modification for each of the case specific factors.

20. The method of claim 12, further comprising storing risk analysis history data, the risk analysis history data comprising updates to the risk data made by the one or more users and calculation logs over time.
